(19) United States
(12) Patent Application Publication
(10) Pub. No.: US 2009/0002882 A1
(43) Pub. Date: Jan. 1, 2009

(54) DISK DRIVE UNIT

(75) Inventors: Norio Yoshikawa, Yokohama-shi (JP); Hideharu Ito, Akiruno-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/146,652

(22) Filed: Jun. 26, 2008

(30) Foreign Application Priority Data
Jun. 29, 2007 (JP) 2007-173276

(51) Int. Cl. G11B 33/14

(52) U.S. Cl. 360/97.02

(57) ABSTRACT

According to one embodiment, a disk device includes a recording medium rotated by the spindle motor, and a circulation filter disposed at that corner of the bottom wall which is situated closest to the head on the downstream side of the head. The base includes a guide channel through which an air current is guided to the circulation filter. The guide channel includes a first channel extending straight along a tangent to the recording medium, and a second channel extending straight from the first channel toward the center of rotation of the recording medium and having an outlet opening toward the recording medium. The sidewall includes a wall surface configured to redirect an air current flowing through the first channel toward the center of rotation of the recording medium, the circulation filter being disposed in the second channel.

### CROSS-REFERENCE TO RELATED APPLICATIONS

This application is based upon and claims the benefit of priority from Japanese Patent Application No. 2007-173276, filed Jun. 29, 2007, the entire contents of which are incorporated herein by reference.

### BACKGROUND

1. Field

One embodiment of the present invention relates to a disk drive unit provided with disk recording media rotatable at high speed.

2. Description of the Related Art

In recent years, disk devices, such as magnetic disk devices, optical disc devices, etc., have been widely used as external recording devices of computers or image recording apparatuses.

In general, a magnetic disk device, e.g., a hard disk drive (HDD), is provided with a magnetic disk, spindle motor, magnetic head, carriage assembly, voice coil motor, board unit, etc. The spindle motor rotates the magnetic disk. The head serves to write and read data to and from the disk. The carriage assembly supports the head. The voice coil motor drives the carriage assembly. All these elements are contained in a substantially sealed housing. Further, the HDD is provided with a breathing filter and a circulation filter. The breathing filter is used to remove dust, moisture, and gas components in the open air that flows in through vent holes in the housing. The circulation filter serves to capture dust that is produced in the housing as moving parts operate. The breathing filter, circulation filter, and carriage assembly are arranged around the magnetic disk.

In the magnetic disk device constructed in this manner, the rotational speed of the magnetic disk must be increased in order to perform high-speed data processing. If the disk rotates at high speed, however, an air current is generated in the same direction as the direction of rotation of the disk, whereupon a phenomenon called disk flutter occurs such that the disk is vibrated by the disturbance of the air current. Further, an air current acts on the carriage that supports the magnetic head, thereby causing a displacement of the carriage. In this case, the positioning accuracy of the head with respect to the disk is reduced, so that the recording density fails to be improved.

Proposed in Jpn. Pat. Appln. KOKAI Publication No. 2006-179118, for example, is a device in which a baffle wall is disposed at an inlet of a circulation filter so as to extend along the outer periphery of a magnetic disk, whereby turbulence attributable to the high-speed rotation of the disk can be suppressed. Further proposed in Jpn. Pat. Appln. KOKAI Publication No. 2006-185486, for example, is a device that is provided with an air current guide for guiding an air current passed through a circulation filter from the outer periphery of a magnetic disk toward its center.

Although turbulence of the air current around the circulation filter can be suppressed in each of the magnetic disk devices constructed in this manner, however, a turbulent flow is generated between the circulation filter and a carriage. It is difficult, therefore, to reduce the air current on the carriage.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary plan view showing an HDD according to an embodiment of the invention with its top cover off;

FIG. 2 is an exemplary perspective view of the HDD;

FIG. 3 is an exemplary enlarged perspective view showing a guide channel section of the HDD; and

FIG. 4 is an exemplary plan view showing an HDD as a comparative example.

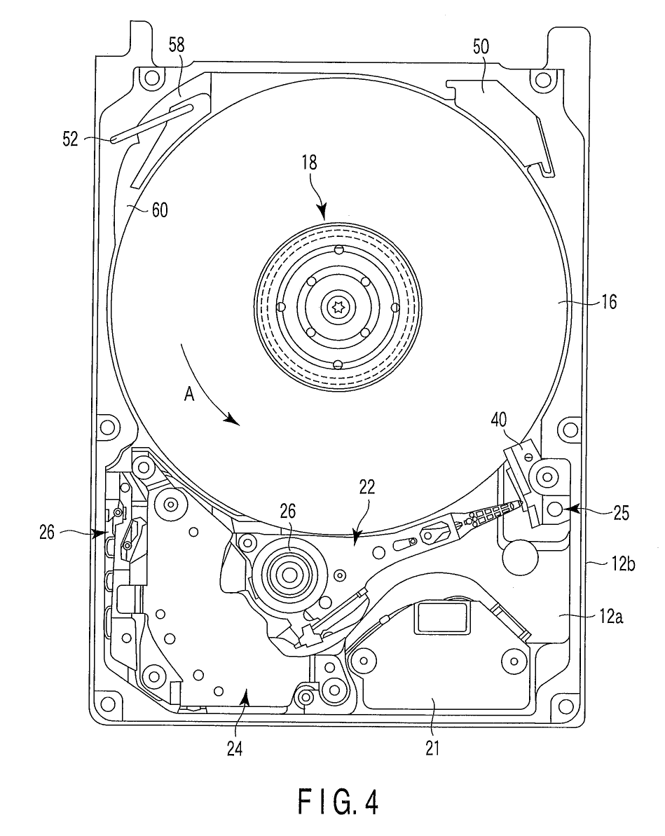

### DETAILED DESCRIPTION

Various embodiments according to the invention will be described hereinafter with reference to the accompanying drawings. In general, according to one embodiment of the invention, a disk device comprises: a case provided with a base including a rectangular bottom wall and a sidewall set up along a peripheral edge of the bottom wall; a spindle motor arranged on the bottom wall of the base; a disk-shaped recording medium which is supported and rotated by the spindle motor; a head which processes information for the recording medium; a carriage which includes a bearing portion situated beside the outer periphery of the recording medium and supports the head for movement with respect to the recording medium; a ramp which is located beside the outer periphery of the recording medium on the downstream side of the bearing portion with respect to the direction of rotation of the recording medium and supports the head when the head is moved to the outside of the outer peripheral edge of the recording medium; and a circulation filter disposed at that corner of the bottom wall which is situated closest to the head on the downstream side of the head with respect to the direction of rotation of the recording medium, the sidewall of the base having an inner surface which is formed in a circular-arc shape along the outer peripheral edge of the recording medium and faces the outer peripheral edge of the recording medium across a gap, the base including a guide channel which is formed in the sidewall and through which an air current is guided to the circulation filter, the guide channel having an inlet and including a first channel which extends straight along a tangent to the recording medium and a second channel which extends straight from the first channel toward the center of rotation of the recording medium and has an outlet opening toward the recording medium, the sidewall including a wall surface which defines the second channel, extends at right angles to the first channel, and is configured to redirect an air current flowing through the first channel toward the center of rotation of the recording medium, the circulation filter being disposed in the second channel.

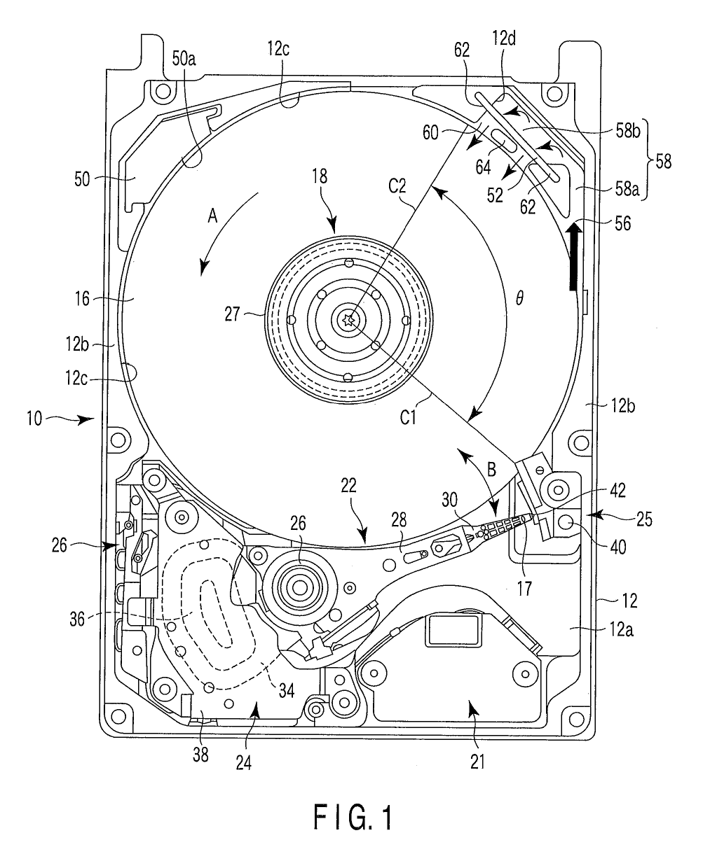

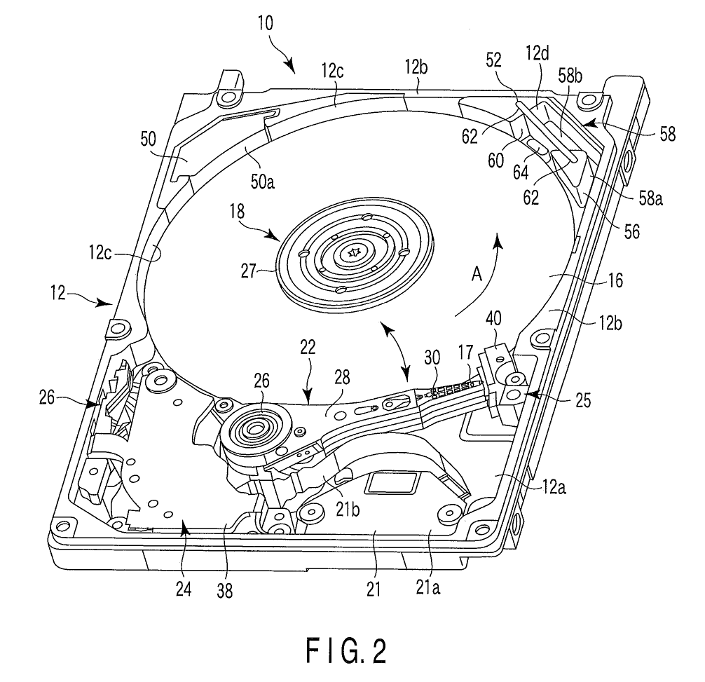

An HDD according to an embodiment of this invention will now be described in detail with reference to the accompanying drawings. FIGS. 1 and 2 show the internal construction of the HDD with its top cover off. As shown in FIGS. 1 and 2, the HDD is provided with a case 10. The case 10 includes a base 12 in the form of an open-topped rectangular box and a top cover (not shown), which is fastened to the base by screws so as to close a top opening of the base. The base 12 includes a rectangular bottom wall 12a and a sidewall 12b set up along the peripheral edge of the bottom wall.

The case 10 contains therein a spindle motor 18, which is mounted on the bottom wall 12a of the base 12, and two magnetic disks 16 (only upper one of which is shown) that are supported and rotated by the spindle motor. Further, the case 10 contains magnetic heads 17, a carriage assembly 22, a voice coil motor (VCM) 24, a ramp load mechanism 25, an inertia latch mechanism 26, and a board unit 21. The magnetic heads serve to record and reproduce information to and from the disks 16. The carriage assembly 22 supports the heads for movement with respect to the disks 16. The VCM 24 serves to rotate and position the carriage assembly. The ramp load mechanism 25 holds the magnetic heads in a retracted position at a distance from the magnetic disks when the heads are moved to the outermost peripheries of the disks. The inertia latch mechanism 26 serves to hold the carriage assembly in a retracted position when the HDD is jolted. The board unit 21 is provided with a preamplifier and the like. A printed circuit board (not shown) is screwed onto the outer surface of the bottom wall 12a of the base 12. The circuit board causes the board unit 21 to control the respective operations of the spindle motor 18, VCM 24, and magnetic heads.

Each magnetic disk 16 has a diameter of, for example, 65 mm (2.5 inches). It includes magnetic recording layers on its upper and lower surfaces, individually. The two magnetic disks 16 are coaxially fitted on a hub (not shown) of the spindle motor 18 and clamped by a clamp spring 27. Thus, the disks 16 are supported parallel to the bottom wall 12a of the base 12. The magnetic disks 16 are rotated in the direction of arrow A at a predetermined speed, e.g., at 5,400 or 7,200 rpm, by the spindle motor 18.

That part of the sidewall 12b which is situated substantially halfway longitudinally relative to the base 12 surrounds the respective outer peripheral edges of the magnetic disks 16. An inner surface 12c of the sidewall 12b has the form of a circular arc along the outer peripheral edges of the disks 16 and faces the disk edges across a narrow gap.

The carriage assembly 22 is provided with a bearing portion 26 fixed on the bottom wall 12a of the base 12 and four arms 28 extending from the bearing portion. The bearing portion 26 is spaced from the center of rotation of the magnetic disks along the base 12 and situated near the outer peripheral edges of the disk. The four arms 28 are situated parallel to the surfaces of the magnetic disks 16 and at predetermined spaces from one another and extend in the same direction from the bearing portion 26. The carriage assembly 22 is provided with elastically deformable suspensions 30 each in the form of an elongated plate. Each suspension 30 is formed of a leaf spring, the proximal end of which is fixed to the distal end of its corresponding arm 28 by spot welding or adhesive bonding and extends from the arm. Each suspension 30 may be formed integrally with its corresponding arm 28.

Each magnetic head 17 is mounted on an extended end of each suspension 30. The magnetic head 17 includes a substantially rectangular slider and a write/read magnetoresistive (MR) head formed on the slider. The head 17 is fixed to a gimbal portion that is formed on the distal end portion of the suspension 30. Each two of the four magnetic heads 17 that are mounted individually on the suspensions 30 are situated opposite each other so as to sandwich each magnetic disk from both sides.

The carriage assembly 22 includes a support frame 34 that extends from the bearing portion 26 so as to be directed opposite from the arms 28. The support frame 34 supports a voice coil 36 that constitutes a part of the VCM 24. The support frame 34 is a plastic structure that is molded integrally on the outer periphery of the voice coil 36. The voice coil 36 is situated between a pair of yokes 38 that are fixed on the base 12. The voice coil 36, the yokes 38, and a magnet (not shown) fixed to one of the yokes constitute the VCM 24. When the voice coil 36 is energized, the carriage assembly 22 rocks in the direction of arrow B around the bearing portion 26, whereupon the magnetic heads 17 are moved onto desired tracks of the magnetic disks 16 and positioned there. Thereupon, the heads 17 can write and read information to and from the disks 16. The carriage assembly 22 and the VCM 24 constitute a head actuator.

The ramp load mechanism 25 includes a ramp 40 disposed on the bottom wall 12a of the base 12 and located outside the magnetic disks 16 and tabs 42 that extend individually from the respective distal ends of the suspensions 30. The ramp 40 is situated on the downstream side of the bearing portion 26 with respect to the direction of rotation A of the disks 16. When the carriage assembly 22 rocks so that the magnetic heads 17 are rocked to the retracted position outside the disks 16, each tab 42 engages with a ramp surface formed on the ramp 40, and is then pulled up along the slope of the ramp surface to unload the heads 17.

The board unit 21 has a body 21a, which is formed of a flexible printed circuit board and fixed on the bottom wall 12a of the base 12. Electronic components, such as a head amplifier, are mounted on the body 21a. The board unit 21 includes a main flexible printed circuit board (main FPC) 21b extending from the body 21a. An extended end of the main FPC 21b is connected to the vicinity of the bearing portion 26 of the carriage assembly 22. Further, the extended end is electrically connected to the magnetic heads 17 by cables (not shown) on the arms 28 and the suspensions 30. Connectors (not shown) for connection with the printed circuit board are mounted on the bottom surface of the body of the board unit 21.

The HDD is provided with a breathing filter 50 and a circulation filter 52. The breathing filter 50 is used to remove dust, moisture, and gas components in the open air that flows in through vent holes in the top cover. The circulation filter 52 serves to capture dust that is produced in the housing as moving parts operate. These filters 50 and 52 are arranged around the magnetic disks 16.

More specifically, the circulation filter 52 is in the form of, for example, a rectangular mat, and is disposed at that corner of the base 12 which is situated closest to the magnetic heads 17 or the ramp 40 on the downstream side thereof with respect to the direction of rotation A of the magnetic disks 16.

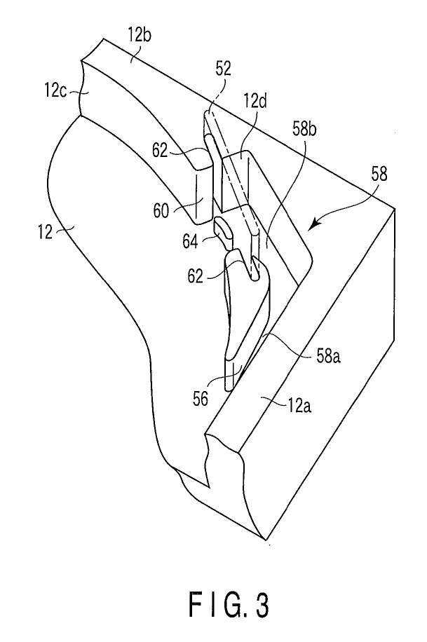

The base 12 is provided with a guide channel 58 in the sidewall 12b through which an air current is guided to the circulation filter 52. As shown in FIGS. 1 to 3, the guide channel 58 has an inlet 56 and includes a first channel 58a and a second channel 58b. The first channel 58a extends straight along a tangent to each magnetic disk 16, while the second channel 58b extends straight toward the center of rotation of the disk 16. The second channel 58b has an outlet 60 that opens toward the center of the disk 16. The opening width of the outlet 60 is twice or more as great as that of the inlet 56. In the present embodiment, the first channel 58a extends straight and is bent in the middle. The second channel 58b extends substantially at right angles to the first channel 58a and spreads along the radius of each disk 16.

The sidewall 12b includes a wall surface 12d that defines the second channel 58b. The wall surface 12d rises upright or at right angles to the bottom wall 12a and extends from the trailing end of the first channel 58a to the outlet 60 at right angles to the first channel 58a. An air current in the first channel 58a strikes the wall surface 12d so that it is redirected substantially at 90° and guided toward the center of rotation of each magnetic disk.

The outlet 60 of the guide channel 58 is disposed in a position at an angle θ of 80 to 110° to that of the ramp 40 in the direction of rotation A of each magnetic disk 16 around its center. Specifically, the outlet 60 is located so that the angle θ between a segment C1 that passes through the center of rotation of each disk 16 and the ramp 40 and a segment C2 that passes through the disk center and the outlet 60 ranges from 80 to 110°.

The circulation filter 52 is disposed in the second channel 58b so as to close the outlet 60. Thus, the filter 52 is located along a tangent to each magnetic disk 16. The circulation filter 52 is held in a predetermined position such that its opposite end portions are engaged individually with slits 62 in the sidewall 12b and that it engages with a positioning projection 64 protruding from the bottom wall 12a.

On the other hand, the breathing filter 50 is disposed at that corner of the base 12 which is situated closest to the circulation filter 52 on the downstream side thereof with respect to the direction of rotation A of the magnetic disks 16. The breathing filter 50 has an arcuate outer surface 50a that is situated in alignment with the inner surface 12c of the sidewall 12b of the base 12.

When the magnetic disks 16 rotate at high speed, according to the HDD constructed in this manner, an air current is produced in their direction of rotation. A part of the air current partially gets into the first channel 58a through the inlet 56 of the guide channel 58 and flows along a tangent to each disk 16 in the first channel. Thereafter, the partial air current is redirected substantially at 90° by the wall surface 12d that defines the second channel 58b. Then, the redirected air current flows in the second channel 58b toward the center of each magnetic disk, that is, along the radius of the disk. As the air current passes through the circulation filter 52, moreover, dust contained therein is captured by the circulation filter 52. Thereafter, the air current is returned toward the magnetic disks 16 through the outlet 60 and joined together with an air current that flows along the outer peripheral edges of the disks. The outlet 60 of the guide channel 58 is disposed within the angular range of 80 to 110° to the ramp 40 with respect to the center of rotation of each disk 16, and the opening width of the outlet 60 is about twice or more as great as that of the inlet 56. Thus, disturbance of air currents at the inlet and the outlet of guide channel 58 can be reduced.

Since the guide channel 58 is bent at right angles so as to extend toward the center of each magnetic disk 16 by the wall surface 12d, moreover, the air current that flows through the guide channel 58 strikes the wall surface 12d so as to be redirected. Accordingly, the flow rate of the air current that flows through the second channel 58b is lower enough than that of the air current that flows along the outermost peripheries of the magnetic disks. When the air currents that flow out individually from the second channel 58b and the outlet 60 join together, therefore, they never have any great influence on the air current that flows along the outermost peripheries of the disks, so that turbulences can be suppressed. Thus, the possibility of disk flutter can be reduced.

Since the first and second channels 58a and 58b are thus linearly bent at right angles to each other, disk flutter can be suppressed without failing to maintain the particle capturing efficiency of the circulation filter 52.

The air current that is discharged toward the center of rotation of each magnetic disk 16 through the outlet 60 flows in the direction of rotation A of the disk, and is further baffled so that it reaches the upstream side of the carriage assembly 22. Even when the disks 16 are rotated at high speed, therefore, an air current that is generated in the vicinity of the disks can be baffled to reduce disk flutter that is caused by a disturbance of the air current. Furthermore, of the air current on the suspensions 30 can be suppressed. Thus, vibration of the magnetic disks attributable to the air current and disturbance displacement of the suspensions can be reduced, so that the positioning accuracy of the magnetic heads with respect to the disks is improved. In consequence, there may be obtained a high-performance magnetic disk device in which the track pitches of the magnetic disks can be shortened and the storage capacity and rotational speed can be increased.

The inventor hereof compared an HDD as a comparative example and the HDD according to the present embodiment for the head positioning accuracy based on disk flutter components. In the comparative example, the outlet 60 of the guide channel 58 and the circulation filter 52 are disposed at an angle of about 180° or more to the ramp 40 in the direction of rotation A of each magnetic disk 16 around its center of rotation. Further, the guide channel extends along a tangent to each disk.

Table 1 below shows the result of comparison for the positioning accuracy. This measurement result indicates mean values for four magnetic heads with respect to two magnetic disks. The smaller the mean value, the higher the positioning accuracy is. For the HDD according to the present embodiment compared with the comparative example, as seen from this result, the positioning accuracy is improved by about 8% at a disk rotational speed of 5,400 rpm and by about 10% at 7,200 rpm.

TABLE 1

| | 7,200 rpm | 5,400 rpm |
|---|---|---|
| Embodiment | 14.2 nm | 8.0 nm |
| Comparative Example | 12.9 nm | 7.4 nm |

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

Although the configuration of the embodiment described above is provided with the two magnetic disks, the number of magnetic disks may be varied as required.

What is claimed is:

1. A disk device comprising:
a case provided with a base including a rectangular bottom wall and a sidewall set up along a peripheral edge of the bottom wall;
a spindle motor arranged on the bottom wall of the base;
a disk-shaped recording medium which is supported and rotated by the spindle motor;
a head which processes information for the recording medium;
a carriage which includes a bearing portion situated beside the outer periphery of the recording medium and supports the head for movement with respect to the recording medium;
a ramp which is located beside the outer periphery of the recording medium on the downstream side of the bearing portion with respect to the direction of rotation of the recording medium and supports the head when the head is moved to the outside of the outer peripheral edge of the recording medium; and
a circulation filter disposed at that corner of the bottom wall which is situated closest to the head on the downstream side of the head with respect to the direction of rotation of the recording medium,
the sidewall of the base having an inner surface which is formed in a circular-arc shape along the outer peripheral edge of the recording medium and faces the outer peripheral edge of the recording medium across a gap,
the base including a guide channel which is formed in the sidewall and through which an air current is guided to the circulation filter, the guide channel having an inlet and including a first channel which extends straight along a tangent to the recording medium and a second channel which extends straight from the first channel toward the center of rotation of the recording medium and has an outlet opening toward the recording medium, the sidewall including a wall surface which defines the second channel, extends at right angles to the first channel, and is configured to redirect an air current flowing through the first channel toward the center of rotation of the recording medium, the circulation filter being disposed in the second channel.

2. The disk device according to claim 1, wherein the outlet of the guide channel is disposed in a position at an angle θ of 80 to 110° to that of the ramp in the direction of rotation of the recording medium around the center of rotation thereof.

3. The disk device according to claim 2, wherein the opening width of the outlet is twice or more as great as that of the inlet.

4. The disk device according to claim 1, wherein the opening width of the outlet is twice or more as great as that of the inlet.

5. The disk device according to claim 1, wherein the circulation filter is in the form of a rectangular mat and is disposed in the second channel so as to extend along a tangent to the recording medium.

6. The disk device according to claim 2, which further comprises a breathing filter disposed at that corner of the bottom wall which is situated closest to the circulation filter on the downstream side of the circulation filter with respect to the direction of rotation of the recording medium, the breathing filter having an arcuate outer surface situated in alignment with the inner surface of the sidewall of the base.
